(19) United States
(12) Patent Application Publication
(10) Pub. No.: US 2015/0030029 A1
(43) Pub. Date: Jan. 29, 2015

(54) Frame Passing Based on Ethertype

(71) Applicants: Parvez Syed Mohamed, Folsom, CA (US); Leonard Knapp, Granite Bay, CA (US); Mark J. Hilton, Rocklin, CA (US); Mark Allen Gravel, Roseville, CA (US); Shaun Wakumoto, Roseville, CA (US)

(72) Inventors: Parvez Syed Mohamed, Folsom, CA (US); Leonard Knapp, Granite Bay, CA (US); Mark J. Hilton, Rocklin, CA (US); Mark Allen Gravel, Roseville, CA (US); Shaun Wakumoto, Roseville, CA (US)

(21) Appl. No.: 14/377,926

(22) PCT Filed: Mar. 26, 2012
(86) PCT No.: PCT/US2012/030512

§ 371 Date: Aug. 11, 2014

(51) Int. Cl. H04L 12/741; H04L 29/06

(52) U.S. Cl. CPC H04L 45/74; H04L 63/08
USPC 370/392

(57) ABSTRACT

Example embodiments disclosed herein relate to passing or forwarding a frame. A frame is received from a first device. The frame includes a first header including a destination Media Access Control (MAC) address followed by a second header including a source MAC address followed by a third header including an Ethertype. The frame is passed or forwarded to a second device based on the Ethertype.

### BACKGROUND

In the networking technology space, there are various types of packets transmitted between source and destination devices. Such packets can be associated with one or more specifications and/or standards, for example, the Institute of Electrical and Electronics Engineers (IEEE) 802.3 standard, the IEEE 802.1AE standard, proprietary specifications, etc. A network device on a network may be expected to deal with various different types of packets.

### BRIEF DESCRIPTION OF THE DRAWINGS

The following detailed description references the drawings, wherein:

FIG. 1 is a block diagram of a system including a pass through switch capable of passing frames based on an Ethertype, according to one example;

FIGS. 2A and 2B are block diagrams of network devices capable of passing through frames based on an Ethertype associated with the respective frames, according to various examples;

FIG. 3 is a flowchart of a method for forwarding a frame based on an Ethertype, according to one example; and

FIG. 4 is a block diagram of a network device capable of determining whether to pass a frame based on an Ethertype, according to one example.

### DETAILED DESCRIPTION

As noted above, network devices can be expected to deal with various types of protocols and packets. These packets can conform to one or more standards. For example, many routers and switches today are compatible with one or more specifications or standards, like IEEE 802.3. As technology grows, additional standards are being added, As such, standards like IEEE 802.1AE defining the IEEE Media Access Control (MAC) Security standard (MACsec), 802.1X defining the Extensible Authentication Protocol (EAP) over IEEE 802, and the like are being added. These standards may, for example, help make a network more secure by adding security features.

However, not all network infrastructure devices support these new technologies, for example, MACsec. In certain cases, standards provide that for a connection between devices to be secure, each network device in the path from the first device to the second device is compatible with the standard. The MACsec standard states that devices forming a secure association be interconnected. A chain of secure connections can be used to provide information from one device to another. Without the direct connection, a MACsec secure association does not form.

A noncompliant switch between two MACsec compatible devices may not allow a MACsec secure channel to form. As such, all traffic being sent and received via the noncompliant device may be required to be unencrypted. As such, when an administrator attempts to upgrade a system to become more secure using a protocol such as the MACsec protocol, the administrator may have to upgrade multiple devices. This upgrade can be a large expenditure for an individual or business.

Accordingly, various embodiments disclosed herein relate to using a network device such as an intermediary switch in a MACsec pass though mode. In certain scenarios, the network device can be an ordinary network device in the customer's infrastructure that can be upgraded via a software upgrade. In other scenarios, a manufacturer can sell the network device configured with the MACsec pass through mode. This can allow MACsec devices not directly connected to form a secure channel. In one embodiment, the pass though feature can include ignoring 802.1X frames and/or MACsec packets with an Ethertype indicating a MACsec. In certain scenarios, 802.1X frames may include an Ethertype of 0x888E while MACsec frames may include an Ethertype of 0x88E5. For a consumer, a pass through capable device could be cheaper to use compared to a MACsec compliant device because MACsec hardware can add to unit costs.

This is contrary to the 802.1 standard, which states that all Bridge Protocol Data. Units (BPDUs) such as 802.1X frames shall be consumed by the receiving network device (e.g., switch). In this scenario, the intermediary network switch would go against the approach of the standard and forward the 802.1X protocol packets to the next device in a chain to the destination device. If a MACsec client sends an 802.1X protocol packet, the MACsec pass through network device will ignore the packet and forward it on to the next device, the end device being a MACsec device, such as a MACsec switch. The MACsec switch can then respond to the client and the intermediary network device will ignore the 802.1X protocol packets being used to communicate between the MACsec compatible devices. This exchange allows the MACsec enabled devices to negotiate the necessary information to form a secure channel with one another. In certain embodiments, once the secure channel is formed, the intermediary network device no longer inspects any of the traffic sent between the MACsec devices. Multiple pass through network devices can be used in the path between two MACsec compatible end devices.

In certain scenarios, Ethertype is a two-octet field in an Ethernet frame. It is used to indicate which protocol is encapsulated in the payload of the Ethernet frame. In modern applications, Ethertype generally starts at 0x0800. As further detailed below, Ethertype can be placed in an Ethernet frame after a destination MAC address and a Source MAC address. In certain embodiments, a list of Ethertypes may be stored at the pass through switch that can be used to determine which frames are passed through. MACsec frames and 802.1X frames can be on the list. Further, the list can be preset in firmware and/or variable based on user input.

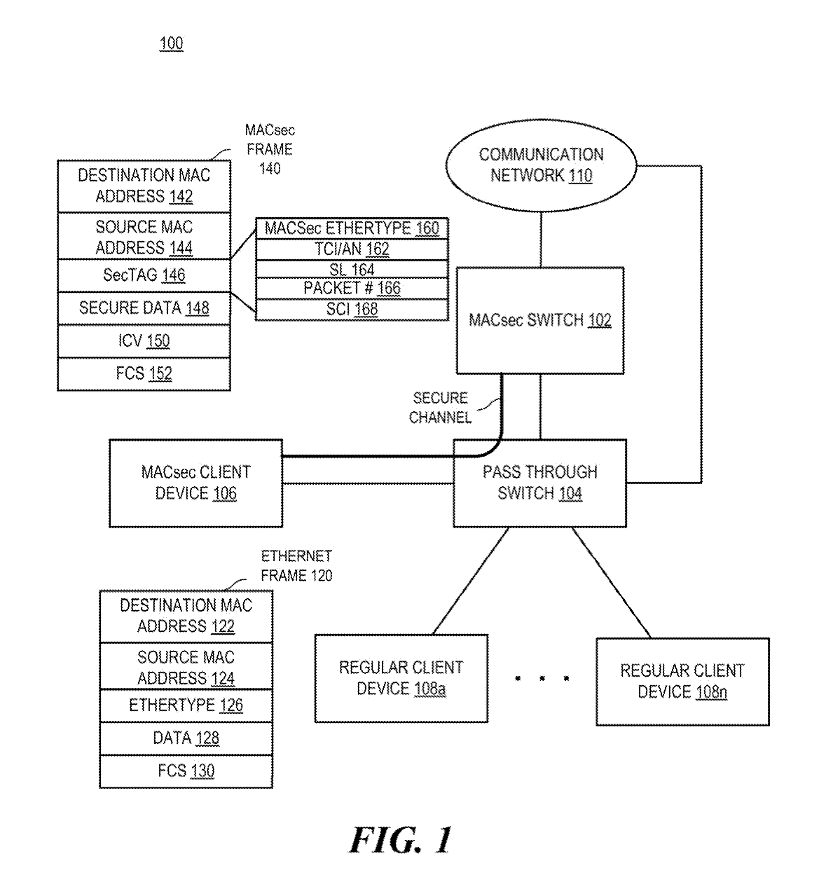

FIG. 1 is a block diagram of a system including a pass through switch capable of passing frames based on an Ethertype, according to one example. The system 100 can include a MACsec Switch 102, a pass through switch 104, a MACsec client device 106 or multiple MACsec client devices, one or more regular client devices 108a-108n, and/or other devices connected via a communication network 110. In certain examples, the MACsec client device 106, the regular client devices 108a-108n, or other devices connected via the communication network 110 are computing devices, such as servers, client computers, desktop computers, mobile computers, etc. Further, in certain embodiments, the MACsec switch 102, the pass through switch 104, the MACsec client device 106, and the regular client devices 108 can be implemented, at least in part, via a processing element, memory, and/or other components,

In one example, client devices such as the MACsec client device 106 and/or regular client device 108 can use a standard Ethernet frame, such as Ethernet frame 120, as a packet to communicate to other devices. Ethernet frame 120 includes a destination MAC address 122 that describes the MAC address of the intended recipient, a source MAC address 124 that describes the MAC address of the sender of the Ethernet frame 120, an Ethertype 126, payload data 128, and a frame check sequence (FCS) 130 that can be used for error detection. In certain scenarios, when connections are made between a regular client device 108 and another device via the pass through switch 104, the regular client device 108 can be authenticated, for example, at the access level, by the pass through switch 104.

Further, the MACsec client device 106 can use one or more types of frames to communicate with other devices, for example, a standard Ethernet frame 120 or a MACsec frame 140. The MACsec frame 140 can include a destination MAC address 142, a source MAC address 144, a security tag (SecTAG) 146, secure data 148 that includes encrypted data, an integrity check value (ICV) 150 that can be calculated based on the contents of the frame, and an FCS 152. The SecTAG 146 can include a MACsec Ethertype 160, tag control information/association number (TCI/AN) 162 including information that may be used to determine a version of the MACsec protocol to be used in the packet and may include information that can be used to transmit the frame over a secure channel, a short length (SL) 164 that can be used to determine the number of bytes of the secure data 148 that is between the last byte of the of the SecTAG 146 and the first byte of the ICV 150, a packet number 166, and a Secure Channel Identifier 168 that can be used to identify a source address and port that transmitted the frame. In this example, the MACsec Ethertype 160 is directly after the source MAC address 144. As such the Ethertype is in the same location in the MACsec Frame 140 and the Ethernet Frame 120.

In one example, the MACsec client device 106 wishes to connect to another MACsec enabled device via the pass through switch 104. In this example, the communication can be processed via the MACsec switch 102. The MACsec client device 106 can perform 802.1X authentication with the MACsec switch 102 via the pass through switch 104. In this scenario, the pass through switch 104 receives one or more 802.1X frames from the MACsec client device 106 and parses the frames to determine that the frames should be passed through the pass through switch 104. The frames are not consumed by the pass through switch 104, which goes against the 802.1X specification. The decision to pass through the switch can be based on the Ethertype of the frame. In one scenario, an 802.1X protocol frame has the Ethertype of 0x888E. This Ethertype can be configured to be passed through the pass through switch 104 to another device. in certain scenarios, the MACsec switch 102 can be directly connected to the pass through switch 104 and can use the 802.1X frame. In other scenarios, multiple pass through switches can be connected between the MACsec devices. Each of the pass through switches can be configured to pass through 802.1X frames. An exchange can occur between the two MACsec compatible devices (e.g., the MACsec client device 106 and the MACsec switch 102) for the authentication. Each of the 802.1X frames to/from the MACsec compatible devices are passed through. As such, a secure association can be created between the MACsec compatible devices. This can be enabled by the pass through switch 104 and/or other pass through switches in between the MACsec compatible devices passing through the pass through switches.

Once the secure association is made, MACsec frames can be sent to/from the MACsec compatible devices. These frames can include secure data The pass through switch 104 can parse frames received to determine the Ethertype. If the Ethertype indicates that the frame is a MACsec frame, for example, if the frame has an Ethertype of 0x88E5, the pass through switch 104 can pass the frame to the next device in the path between MACsec compatible devices. In one example, the next device is another pass through switch between the MACsec devices. In another example, the next device is a MACsec compatible device, such as MACsec client device 106 or MACsec switch 102. In certain embodiments, passing through the frames means that the frames are forwarded to the next device without alteration. In certain embodiments, without alternation means that the frame forwarded is the same, bit by bit, as the frame.

At this stage, in certain examples, the pass through switch 104 has no visibility to the payload of the client traffic. As such the pass through device does not perform any enforcement at the access layer. This type of enforcement can include, for example, Access Control Lists (ACLs), Quality of Service (QoS), and other filtering policies based on contents other than MAC address. In certain examples, any such filtering policies can be performed at a MACsec compatible device, such as MACsec switch 102. As noted above, this type of access control can be implemented by the pass through switch 104 when other frames are received, for example, frames not associated with Ethertypes that are associated with a pass through list.

The communication network 110 can use wired communications, wireless communications or combinations thereof. Further, the communication network 110 can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, the communication network 110 can be in the form of a direct network link between devices (e.g., MACsec switches, pass through switches, other switches, routers, etc.). Various communications structures and infrastructure can be utilized to implement the communication network(s).

By way of example, the MACsec client device 106, regular client devices 108, pass through switches, MACsec switches, etc. communicate with each other and other components with access to the communication network 110 via a communication protocol or multiple protocols. A protocol can be a set of rules that defines how nodes of the communication network 110 interact with other nodes. Further, communications between network nodes can be implemented by exchanging discrete packets of data or sending messages. Packets can include header information associated with a protocol (e.g., information on the location of the network node(s) to contact) as well as payload information.

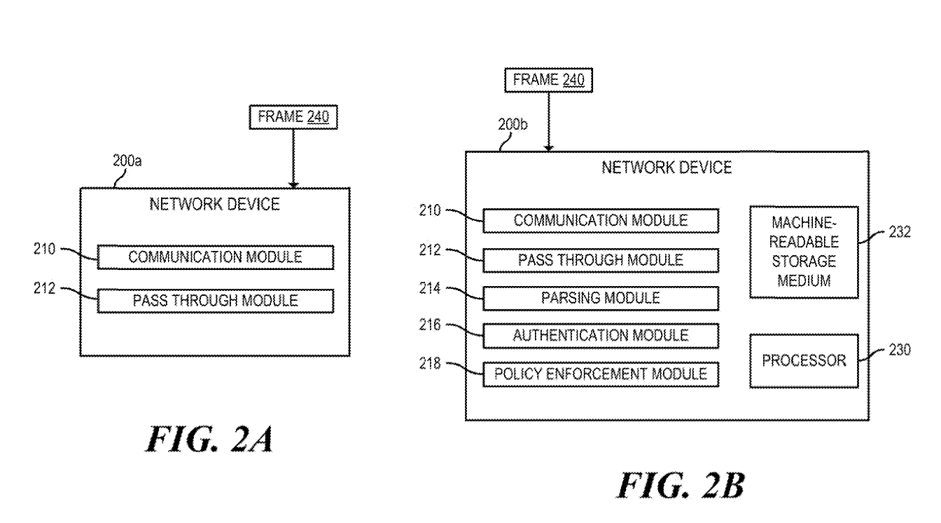

FIGS. 2A and 2B are block diagrams of network devices 200a, 200b capable of passing through frames based on an Ethertype associated with the respective frames, according to various examples. The respective network devices 200a, 200b may be a switch, a router, a bridge, or any other computing device that receives, processes, and/or forwards packets and/or frames. In one example, an inline device, such as a Voice over Internet Protocol (VoIP) phone, can be considered a network device. In another example, pass through switch 104 can be considered a network device. As shown in FIG. 2A, the network device 200a can include a communication module 210 and a pass through module 212. Further, in certain examples, the network device 200b can also include a parsing module 214, an authentication module 216, a policy enforcement module 218, a processor 230, and a machine-readable storage medium 232.

As discussed in reference to system 100, the network device 200 can receive frames 240 from a connected device (e.g., a regular client device 108, a MACsec client device 106, a MACsec switch 102, another network device, etc.). A communication module 210 of the network device 200 receives a frame 240. As noted above, the frame can include a first header portion associated with a destination MAC address followed by a second header portion associated with a source MAC address, which is followed by a third header portion that is associated with an Ethertype. Examples of such frames include MACsec frame 140 and Ethernet frame 120. A MACsec frame can be associated with a 0x88E5 Ethertype. In some examples, a frame can include a protocol packet, such as an 802.1X frame. In some embodiments, a protocol packet is a frame that is associated with a set of digital system message rules, such as 802.1X. As noted above, 802.1X frames may be associated with a particular Ethertype, for example, 0x888E.

The parsing module 214 can perform a syntactic analysis to analyze the header portions to determine the Ethertype of the frame 240. Further, the pass through module 212 can determine whether to pass the frame to another device (e.g., a MACsec client device, a MACsec switch, another pass through device in the path to another MACsec compatible device, etc.) based on the Ethertype. In certain embodiments, the passing of the frame is done without modification of the frame. As noted above, in one example, the pass through module 212 determines to pass the frame if the Ethertype reflects an associated protocol frame (e.g., an 802.1X frame with an Ethertype of 0X888E) or a frame with secure data (e.g., a MACsec frame with an Ethertype of 0x88E5). In certain embodiments, these Ethertypes can be associated with a list. If the Ethertype matches an Ethertype on the list, the frame is passed. In other embodiments, the Ethertype determination can be hard coded.

In one example, client device sends a standard Ethernet frame. The communication module 210 receives the, frame and parses the frame. The Ethertype reflects a packet that is associated with another protocol than ones on the list. As such, the pass through module 212 does not merely pass the frame to the next device on its path. Instead, the network device 200 can use an authentication module 216 to perform an access layer authentication for the device associated with the frame. Further, the policy enforcement module 218 can perform enforcement of policies at the access layer (e.g., filtering, use of ACLs, QoS, etc.).

In another example, a MACsec client sends an 802.1X frame to initiate a secure channel to another MACsec device, for example, a MACsec switch. The frame is received at the communication module 210. The pass through module 212 determines that the frame is to be passed based on its Ethertype. As such, the pass through module 212 can cause the communication module 210 to send the unaltered frame to the MACsec device. 802.1X frames can be passed through the network device 200 in this manner to create a secure connection between the MACsec devices.

Then, the MACsec client can send a MACsec frame to the other MACsec device. The communication module 210 can receive the frame and the pass through module 212 can determine that the frame should be passed through based on the Ethertype. In this scenario, access layer authentication of 802.1X packets and/or access layer validation of MACsec frames is not performed at the network device 200. However, access layer authentication or validation may be performed at an associated MACsec switch. As such, MACsec frames can pass through the network device 200 on their way to/from the MACsec devices. In certain embodiments, access layer authentication can include 802.1X authentication that validates that a client has valid credentials and/or is allowed on the network. After a successful authentication, 802.1X can also be used to perform a MACsec Key Agreement (MKA) negotiation between MACsec devices to obtain symmetric keys used for MACsec encryption of their secure channel. Encrypted MACsec frames can be validated using the ICV at the MACsec devices.

A processor 230, such as a central processing unit (CPU) or a microprocessor suitable for retrieval and execution of instructions and/or electronic circuits can be configured to perform the functionality of any of the modules 210, 212, 214, 216 described herein. The processor 230 can also be a special purpose networking processor. In certain scenarios, instructions and/or other information, such as an Ethertype list, a buffer, a cache, etc. can be included in machine-readable storage medium 232 or other memory. Moreover, in certain embodiments, some components can be utilized to implement functionality of other components described herein.

Each of the modules 210-216 may include, for example, hardware devices including electronic circuitry for implementing the functionality described herein. In addition or as an alternative, each module 210-216 may be implemented as a series of instructions encoded on a machine-readable storage medium 232 of network device 200 and executable by processor 230. It should be noted that, in some embodiments, some modules are implemented as hardware devices, while other modules are implemented as executable instructions.

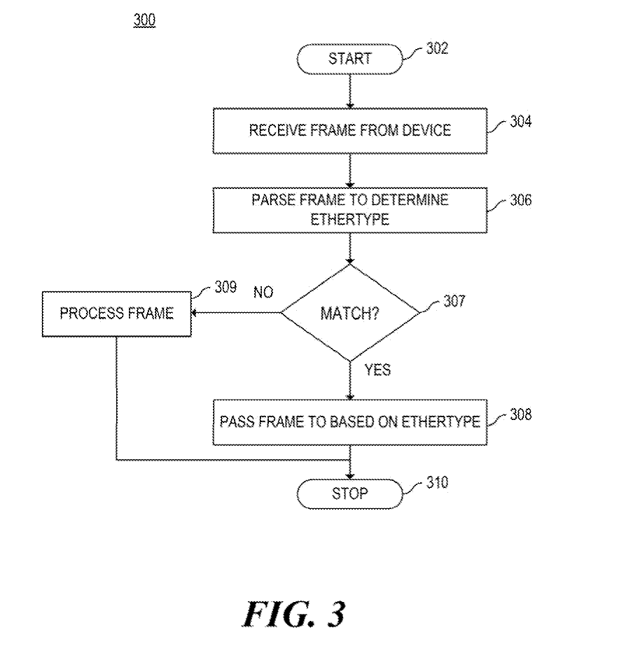

FIG. 3 is a flowchart of a method for forwarding a frame based on an Ethertype, according to one example. Although execution of method 300 is described below with reference to network device 200, other suitable components for execution of method 300 can be utilized (e.g., pass through switch 104). Additionally, the components for executing the method 300 may be spread among multiple devices. Method 300 may be implemented in the form of executable instructions stored on a machine-readable storage medium, such as storage medium 232, and/or in the form of electronic circuitry.

Method 300 may start at 302 and proceed to 304 a communication module 210 of the network device 200 receives a frame from a client device (e.g., regular client device 108, MACsec client device 106, etc.). The frame can include a first header field including a destination MAC address followed by a second header field including a source MAC address, followed by a third header field including an Ethertype. Examples of such a header include MACsec frame 140 and Ethernet frame 120. As such, the frame can be a standard MACsec frame, a standard Ethernet frame, a frame compliant with the 802.1X specification etc.

A parsing module 214 of the network device 200 then parses the frame to determine the Ethertype (306). Then, the frame can be passed or forwarded to a second device based on whether the Ethertype matches an Ethertype that should be passed (307). In one example, at 308, the frame is forwarded if the frame has an Ethertype that reflects a MACsec frame (e.g., 0x88E5) or an 802.1X frame (e.g., 0x888E). The second device can be a secure device such as a MACsec device like MACsec switch 102. In certain examples, the frame can reach the second secure device via other pass through devices. If the Ethertype does not match an Ethertype that should be passed through, at 309, the network device 200 can process the frame. Then, at 310, the method 300 can stop. The network device 200 can continue other functionality, for example, processing another frame from one of the devices.

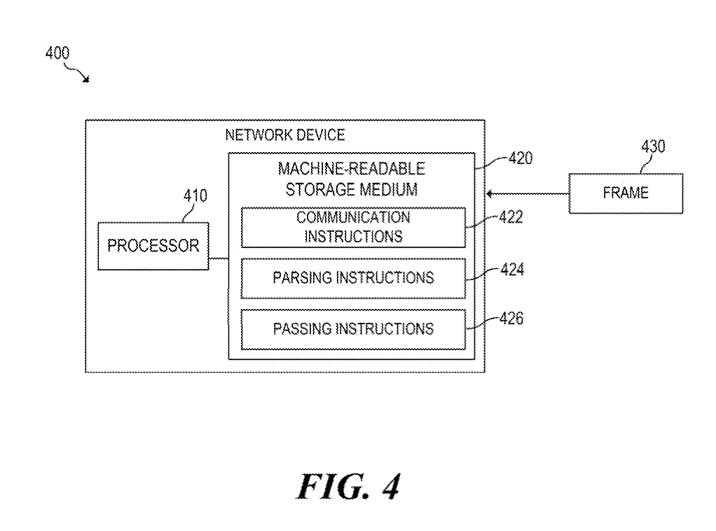

FIG. 4 is a block diagram of a network device capable of determining whether to pass a frame based on an Ethertype, according to one example. The network device 400 includes, for example, a processor 410, and a machine-readable storage medium 420 including instructions 422, 424, 426 for determining whether to pass a frame based on an Ethertype, Network device 400 may be, for example, a network switch, a router, etc.

Processor 410 may be, at least one central processing unit (CPU), at least one semiconductor-based microprocessor, at least one special purpose processing unit, other hardware devices suitable for retrieval and execution of instructions stored in machine-readable storage medium 420, or combinations thereof. For example, the processor 410 may include multiple cores on a chip, include multiple cores across multiple chips, multiple cores across multiple devices, or combinations thereof. Processor 410 may fetch, decode, and execute instructions 422, 424, 426 to implement tasks detailed in method 300. As an alternative or in addition to retrieving and executing instructions, processor 410 may include at least one integrated circuit (IC), other control logic, other electronic circuits, or combinations thereof that include a number of electronic components for performing the functionality of instructions 422, 424, 426.

Machine-readable storage medium 420 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 420 may be encoded with a series of executable instructions for determining whether to pass a frame to a second device based on an Ethertype.

In one example, firmware of the network device 400 can be upgraded to include instructions 422, 424, 426. For example, a legacy network may include switches that are not compliant with a particular standard, for example, not MACsec compliant. The firmware for such a legacy switch can be upgraded to include the instructions 422, 424, 426 to selectively pass a frame to another device.

In one example, the network device 400 can receive a frame 430 from a first device. The frame 430 can include a first header field including a destination MAC address followed by a second header field including a source MAC address followed by a third header field including an Ethertype. As noted above, the frame 430 can be at least one of a standard MACsec frame and a standard Ethernet frame. Further, the frame 430 can be associated with a protocol, for example, the 802.1X protocol.

Parsing instructions 424 can cause the processor 410 to parse the header fields to determine the Ethertype. Then, the processor 410 can execute the passing instructions 426 to determine whether to pass the frame to a second device based on the Ethertype. In one example, if the Ethertype indicates an 802.1X frame (e.g., Ethertype of 0x888E) or a MACsec frame (e.g., Ethertype 0x88E5), the processor 410 determines to pass the frame to the second device. The second device can be a MACsec compatible device. Further, the second device can be another network device. The other network device may also be used to pass the frame onto an eventual secure device.

In one example, the determined Ethertype is associated with a protocol packet type such as 802.1X. The network device 400 can forward the frame 430 without consuming the frame. As noted above, this goes against the 802.1X protocol. This can be used to create a secure channel between the first device and a second secure device. Multiple such frames can be passed through the network device 400 to communicate between end devices to establish the secure channel.

In another example, the determined Ethertype is associated with a MACsec frame. The frame can be sent after a secure channel is established. This frame can be parsed and a determination can be made as to whether the frame should be passed. In this example, the Ethertype can be 0x88E5 and the frame can be passed.

In yet another example, another frame can be received. This frame may have an Ethertype that is not on a list of Ethertypes to forward. Thus, the passing instructions 426 executed on the processor 410 can determine not to pass the frame based on the Ethertype. Other switch activity can be performed by the network device 400 on the frame. In this scenario, the network device 400 may perform an access layer authentication for the device it received the frame from and/or for the frame based on header information.

What is claimed is:

1. A network device comprising:
a communication module to receive a frame from a first device, wherein the frame includes a first header portion associated with a destination media access control address followed by a second header portion associated with a source media access control address that is followed by a third header portion associated with an Ethertype; and
a pass through module to determine whether to pass the frame to a second device, without modification of the frame, based on the Ethertype.

2. The network device of claim 1, further comprising:
a parsing module to parse the header portions to determine the Ethertype.

3. The network device of claim 2, wherein the communication module passes the frame if the Ethertype is one of 0x88E5 and 0x888E.

4. The network device of claim 1, wherein the frame is at least one of a standard Media Access Control Security frame and a standard Ethernet frame.

5. The network device of claim 1, wherein the frame is a protocol packet.

6. The network device of claim 1, wherein the first device is a Media Access Control Security client and the second device is a Media Access Control Security switch.

7. The network device of claim 1, further comprising:
an authentication module, wherein if the pass through module determines that the frame should not be passed through, the authentication module performs access layer authentication for the first device.

8. A non-transitory machine-readable storage medium storing instructions that, if executed by at least one processor of a device, cause the device to:
receive a frame from a first device, wherein the frame includes a first header field including a destination media access control address followed by a second header field including a source media access control address followed by a third header field including an Ethertype;
parse the frame to determine the Ethertype; and
determine whether to pass the frame to a second device based on the Ethertype.

9. The non-transitory machine-readable storage medium of claim 8, further comprising instructions that, if executed by the at least one processor, cause the device to:
pass the frame to the second device if the Ethertype is one of 0x88E5 and 0x888E.

10. The non-transitory machine-readable storage medium of claim 8, wherein the frame is at least one of a standard Media Access Control Security frame and a standard Ethernet frame.

11. The non-transitory machine-readable storage medium of claim 8, further comprising instructions that, if executed by the at least one processor, cause the device to:
determine that the EtherType is a protocol packet type to be passed; and
forward the frame to the second secure device without consuming frame.

12. The non-transitory machine-readable storage medium of claim 8, further comprising instructions that, if executed by the at least one processor, cause the device to:
determine not to pass the frame based on the Ethertype; and
perform access layer authentication for the first device.

13. A method comprising:
receiving a frame from a client device wherein the frame includes a first header field including, a destination media access control address followed by a second header field including a source media access control address followed by a third header field including an Ethertype;
parsing the frame to determine the Ethertype; and
forwarding the frame to a second secure device based on the Ethertype.

14. The method of claim 13, wherein the frame is forwarded if the Ethertype is one of 0x88E5 and 0x888E.

15. The method of claim 13, wherein the frame is at least one of a standard Media Access Control Security frame and a standard Ethernet frame.
